(19) United States
(12) Patent Application Publication
(10) Pub. No.: US 2006/0095420 A1
(43) Pub. Date: May 4, 2006

(54) System, device, method, program, and storage medium for human resources registration and retrieval

(76) Inventors: Shiroh Ikegami, Tokyo (JP); Hiroko Mano, Tokyo (JP)

Correspondence Address: DICKSTEIN SHAPIRO MORIN & OSHINSKY LLP, 2101 L Street, NW, Washington, DC, 20037, US

(21) Appl. No.: 11/244,066

(22) Filed: Oct. 6, 2005

(30) Foreign Application Priority Data
Oct. 21, 2004 (JP) JP2004-307114

(51) Int. Cl. G06F 17/30

(52) U.S. Cl. 707/3

(57) ABSTRACT

A human resources retrieval system includes a client computer and a human resources retrieval device. The client computer and the human resources retrieval device are connected to a network. The client computer specifies a search condition. The human resources retrieval device performs a personnel search and sends a search result to the client computer. The human resources retrieval device includes a profile database, a retriever, and an adjuster. The profile database stores personnel profiles containing human resources data. The retriever searches the profile database for human resources data in accordance with the search condition specified by the client computer. The adjuster adjusts the human resources data by referring to a profile of a searcher and profiles corresponding to the human resources data stored in the profile database.

### CROSS-REFERENCE TO RELATED APPLICATIONS

The present application is based on and claims priority to Japanese patent application No. 2004-307114 filed on Oct. 21, 2004 in the Japan Patent Office, the entire contents of which are incorporated herein by reference.

### BACKGROUND OF THE INVENTION

1. Field of the Invention

The present invention relates to a system, device, method, program, and storage medium for human resources registration and retrieval, and more particularly to a system, device, method, program, and storage medium for human resources registration and retrieval capable of using personnel data of a searcher to effectively search for personnel satisfying a search condition on a network.

2. Description of the Background Art

When a company starts a new business, it is necessary to gather personnel qualified for the new business. Those qualified personnel can be located through organizations inside and outside the company. Conventionally, the search for the human resources data is conducted by a searcher through a database storing personnel data of individuals to be located, including, for example, an individual name, organizations to which an individual belongs, contact information such as a telephone number, a job record, a specialty, and skills.

One example is a background human resources retrieval system that uses the Internet and is specialized for a search of engineering personnel. Such a human resources retrieval system includes an engineer database storing skills and conditions associated with registered engineers and a performance database storing data performance history data about each engineer. With this human resources retrieval system, a user who needs personnel data can execute a search and obtain data about a target profile of an engineer in real time. Such human resources retrieval system can manage almost an entire process beginning from interviewing and ending in contracting with qualified engineers. Thus, the human resources retrieval system satisfies the user as well as the engineers.

The above-described human resources retrieval system is suitable for a case of static and fixed data such as, for example, a name, an organization, and contact information such as a telephone number of each registered engineer. However, the system requires the registered engineers to update dynamic data such as, for example, the specialty and the job history of each registered engineer. Maintaining and updating the data in the databases require a substantial amount of cost and an extra burden on each registered engineer.

Another example is a background human resources retrieval system that is operable in a computer network environment. The human resources retrieval system includes a client system, a server system, and a personnel data database system. The client system sends a search condition specified by a searcher to the server system which previously stores document data created from resource documents originated by respective authors including, for example, engineers. Upon a receipt of the search condition, the server system retrieves author data from the document data based on the search condition. The server system then sorts the author data by author in association with the personnel data database system and produces a list of authors as a search result. Then, the server system sends the author list to the client system. When the search condition matches data about a particular person, the server system sends detailed data about this particular person to the client system. Thus, the dynamic data is handled without placing an extra burden on the engineer while the static data can easily be maintained in a way it was.

Another example of a background human resources retrieval system is a knowledge distribution system. The knowledge distribution system includes a first server having a first database and a second server having a second database. The first database stores data about businesses. The second database stores a plurality of technical papers such as research reports and technical reports prepared as technical documents by respective authors, e.g., the engineers. The first and second servers are connected to a network. A client computer is connected with the first and second servers via the network. The client computer sends a first keyword or a search condition specified by a searcher for an idea relating to a business. The first server receives the first keyword. In the first server, the first database automatically retrieves a second keyword corresponding to the first keyword, and sends the second keyword to the second server. When the second server receives the second keyword, the second database automatically retrieves as a search result at least one document and its author based on the second keyword, and then sends the search result to the client computer. Thus, the document or the author of the document can be retrieved.

### SUMMARY OF THE INVENTION

This specification describes a novel human resources retrieval system. In one aspect of the present invention, the novel human resources retrieval system includes a client computer and a human resources retrieval device. The client computer and the human resources retrieval device are connected to a network. The client computer is configured to specify a search condition. The human resources retrieval device is configured to perform a personnel search and to send a search result to the client computer.

The human resources retrieval device includes a profile database, a retriever, and an adjuster. The profile database is configured to store personnel profiles. The retriever is configured to search the profile database for human resources data in accordance with the search condition specified by the client computer. The adjuster is configured to adjust the human resources data by referring to a profile of a searcher and profiles corresponding to the human resources data stored in the profile database.

The search result sent to the client computer may include the human resources data adjusted by the adjuster. The profile of the searcher may be stored in the profile database and externally entered.

The human resources retrieval system may further include a document registration device connected to the network. The document registration device may include a document database configured to store documents accompanied by data of respective authors. The retriever may be configured to search the profile database and the document database for human resources data in accordance with the search condition specified by the client computer. The human resources data may include data of authors corresponding to documents satisfying the search condition.

The document registration device may further include a profile creator configured to create a profile of an author from a document to be registered. The human resources retrieval device may further include a profile register configured to associate the profile created by the profile creator with the author and to register the associated profile into the profile database.

The client computer may include a profile creator configured to create a profile of an author from a document created by the client computer and to send the created profile to the human resources retrieval device. The human resources retrieval device may further include a profile register configured to associate the profile sent from the client computer with the author and to register the associated profile into the profile database.

The profile creator may create the profile of the author by extracting a keyword from the document to be registered. The adjuster may output the data adjusted by a plurality of adjustment methods.

The profile database may store data about acquaintance degrees, including professional, personal and other dealings between and among various individuals in the database, and the adjuster may output an acquaintance degree between personnel corresponding to the human resources data and the searcher.

The adjuster may refer to the profile of the searcher and the profile of personnel corresponding to the human resources data to calculate and output a knowledge sharing degree between the personnel and the searcher.

The client computer may include a display configured to display an element plotted by using a plurality of axes to show the human resources data output by the adjuster. The display may show the human resources data by changing a color and a gradation of the element.

This specification describes a novel human resources registration device. In one aspect of the present invention, the novel human resources registration device includes a profile database, a profile creator, and a profile register. The profile database is configured to store human resources data used for performing a personnel search in accordance with a search condition. The profile creator is configured to create a profile of an author from a document created by the author. The profile register is configured to associate the profile with the author created by the profile creator and to register the associated profile into the profile database.

The profile creator may create the profile of the author by extracting a keyword from the document.

This specification describes a novel human resources retrieval device. In one aspect of the present invention, the novel human resources retrieval device for performing a personnel search in accordance with a search condition includes a profile database, a retriever, and an adjuster. The profile database is configured to store personnel profiles. The retriever is configured to search the profile database for human resources data in accordance with the search condition. The adjuster is configured to adjust the human resources data by referring to a profile of a searcher and profiles corresponding to the human resources data stored in the profile database.

A search result retrieved by the retriever may include the human resources data adjusted by the adjuster. The profile of the searcher may be stored in the profile database and externally entered.

The human resources retrieval device may further include a document database configured to store documents accompanied by data of respective authors. The retriever may be configured to search the profile database and the document database for human resources data in accordance with the search condition. The human resources data may include data of authors corresponding to documents satisfying the search condition.

This specification describes a novel human resources registration method. In one aspect of the present invention, the novel human resources registration method registers human resources data used for performing a personnel search in accordance with a search condition into a profile database. The human resources registration method includes the steps of creating a profile of an author by using a keyword extracted from a document created by the author, associating the profile with the author, and registering the associated profile into the profile database.

This specification describes a novel human resources retrieval method. In one aspect of the present invention, the novel human resources retrieval method for performing a personnel search in accordance with a search condition includes the steps of storing personnel profiles into a profile database, searching the profile database for human resources data in accordance with the search condition, and adjusting the human resources data by referring to a profile of a searcher and profiles corresponding to the human resources data stored in the profile database.

In yet another aspect of the present invention, the human resources retrieval method for performing a personnel search in accordance with a search condition includes the steps of storing personnel profiles into a profile database, storing documents accompanied by data of respective authors into a document database, searching the document database for author data of a document satisfying the search condition as human resources data, and adjusting the human resources data by referring to a profile of a searcher and profiles corresponding to the human resources data stored in the profile database.

This specification describes a novel computer program product. In one aspect of the present invention, the novel computer program product includes computer readable program code means for, when executed on a computer system, carrying out the human resources registration method or the human resources retrieval method including the steps described above.

This specification describes a novel computer readable storage medium. In one aspect of the present invention, the novel computer readable storage medium has recorded thereon computer readable program code means for, when executed on a computer system, for carrying out the human resources registration method or the human resources retrieval method including the steps described above.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings, wherein:

FIG. 1 is a block diagram of a human resources retrieval system according to an exemplary embodiment of the present invention;

FIG. 2 is a lookup table containing data stored in a user database of the human resources retrieval system shown in FIG. 1;

FIG. 3 is a lookup table containing data stored in an organization database of the human resources retrieval system shown in FIG. 1;

FIG. 4 is a block diagram of a document registration server, a human resources retrieval server, and a client computer of the human resources retrieval system shown in FIG. 1;

FIG. 5 is an illustration of a document registration screen of the document registration server shown in FIG. 4;

FIG. 6 is a lookup table containing data stored in a document database of the document registration server shown in FIG. 4;

FIG. 7 is a lookup table containing data stored in an individual profile database of the human resources retrieval server shown in FIG. 4;

FIG. 8 is an illustration for explaining data stored in an acquaintance network database of the human resources retrieval server shown in FIG. 4;

FIG. 9 is a flowchart illustrating operations of a profile register of the human resources retrieval server shown in FIG. 4;

FIG. 10 is an illustration of a human resources search screen of the human resources retrieval server shown in FIG. 4;

FIG. 11 is a block diagram of a profile database and an adjuster of the human resources retrieval server shown in FIG. 4;

FIG. 12 is a flowchart illustrating operations of the profile database and the adjuster for calculating a knowledge sharing degree shown in FIG. 11;

FIG. 13 is a lookup table containing data in an integrated result produced by the adjuster shown in FIG. 11;

FIG. 14 is an illustration of a screen showing the data in the integrated result shown in FIG. 13 in accordance with a knowledge sharing degree;

FIG. 15 is an illustration of a screen showing the data in the integrated result shown in FIG. 13 in accordance with a coauthor frequency;

FIG. 16 is an illustration of a screen showing the data in the integrated result shown in FIG. 13 in accordance with an acquaintance degree;

FIG. 17 is a block diagram of a document registration server, a human resources retrieval server, and a client computer of a human resources retrieval system according to another exemplary embodiment of the present invention;

FIG. 18 is a lookup table containing data in an integrated result produced by the human resources retrieval server shown in FIG. 17; and

FIG. 19 is a block diagram of the human resources retrieval system shown in FIG. 17 including a plurality of groups.

### DETAILED DESCRIPTION OF THE PREFERRED EMBODIMENTS

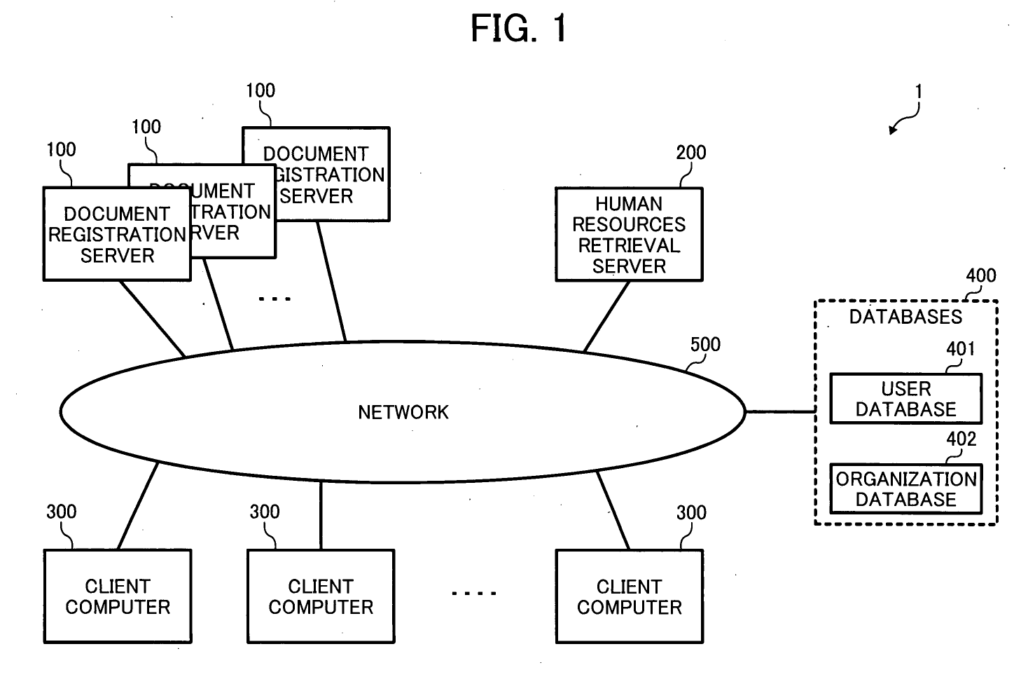

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a human resources retrieval system according to an exemplary embodiment of the present invention is explained.

As illustrated in FIG. 1, a human resources retrieval system 1 includes document registration servers 100, a human resources retrieval server 200, client computers 300, databases 400, and a network 500.

The databases 400 include a user database 401 and an organization database 402.

The human resources retrieval system 1 is configured to retrieve data about a person satisfying a search condition specified by the client computer 300 and to send a search result to the client computer 300. The document registration server 100 is configured to register and store a document created by the person. The client computer 300 is configured to send the search condition to the human resources retrieval server 200 and to receive human resources data about the person satisfying the search condition from the human resources retrieval server 200. The human resources retrieval server 200 is configured to retrieve the human resources data. The databases 400 are configured to store data about a user of the human resources retrieval system 1 and an organization the user belongs to. The network 500 is configured to connect the document registration servers 100, the human resources retrieval server 200, the client computers 300, and the databases 400 with each other.

The user database 401 is configured to store data about the user of the human resources retrieval system 1. The organization database 402 is configured to store data about the organization the user belongs to.

The document registration servers 100, the human resources retrieval server 200, the client computers 300, and the databases 400 are connected with each other via the network 500. Any number of the document registration servers 100 and the client computers 300 may be connected. However, only one human resources retrieval server 200 may be connected in the human resources retrieval system 1. The databases 400 are referred to in order to retrieve data about the user of the human resources retrieval system 1 and the organization to which the user belongs.

Each of the document registration servers 100 stores a document created by an author to maintain and manage the document. The document registration server 100 extracts a profile of the author from the document sent from the client computer 300 and stored into the document registration server 100. The document registration server 100 requests the human resources retrieval server 200 to register the extracted profile into the human resources retrieval server 200. The author of the document or an administrator of the human resources retrieval system 1 sends a command to register, delete, or update the document to the document registration server 100.

The human resources retrieval server 200 retrieves human resources data in accordance with a command sent by the client computer 300. The human resources retrieval server 200 adjusts the retrieved data based on a profile of a searcher, and then sends the adjusted data to the client computer 300.

The document registration server 100 and the human resources retrieval server 200 function as web servers to communicate with the client computer 300. One computer may function as the document registration server 100 and the human resources retrieval server 200.

The client computer 300 generally includes a personal computer in which a web browser is operable. The personal computer may access the document registration server 100 via the network 500 by using the web browser. Thus, the personal computer may send a command to register, delete, or update the document to the document registration server 100, or a command to retrieve human resources data to the human resources retrieval server 200, and may receive and display the retrieved data. The client computer 300 may include a portable device such as a PDA (personal digital assistant) or a cellular phone if the above are satisfied.

The network 500 includes a transmission line for connecting the document registration servers 100, the human resources retrieval server 200, and the client computers 300. The network 500 generally includes a cable. TCP/IP (Transmission Control Protocol/Internet Protocol) and HTTP (Hyper Text Transfer Protocol) may be used as communication protocols. The network 500 may further include any one of a wired network and a wireless network, for example, a LAN (Local Area Network) and a WAN (Wide Area Network).

According to exemplary embodiments described below, internal and external staff members who are authorized to use the human resources retrieval system 1 use the human resources retrieval system 1 of the present invention. The human resources retrieval system 1 is used to provide personnel data.

The user database 401 and the organization database 402 are managed by a system other than the human resources retrieval system 1.

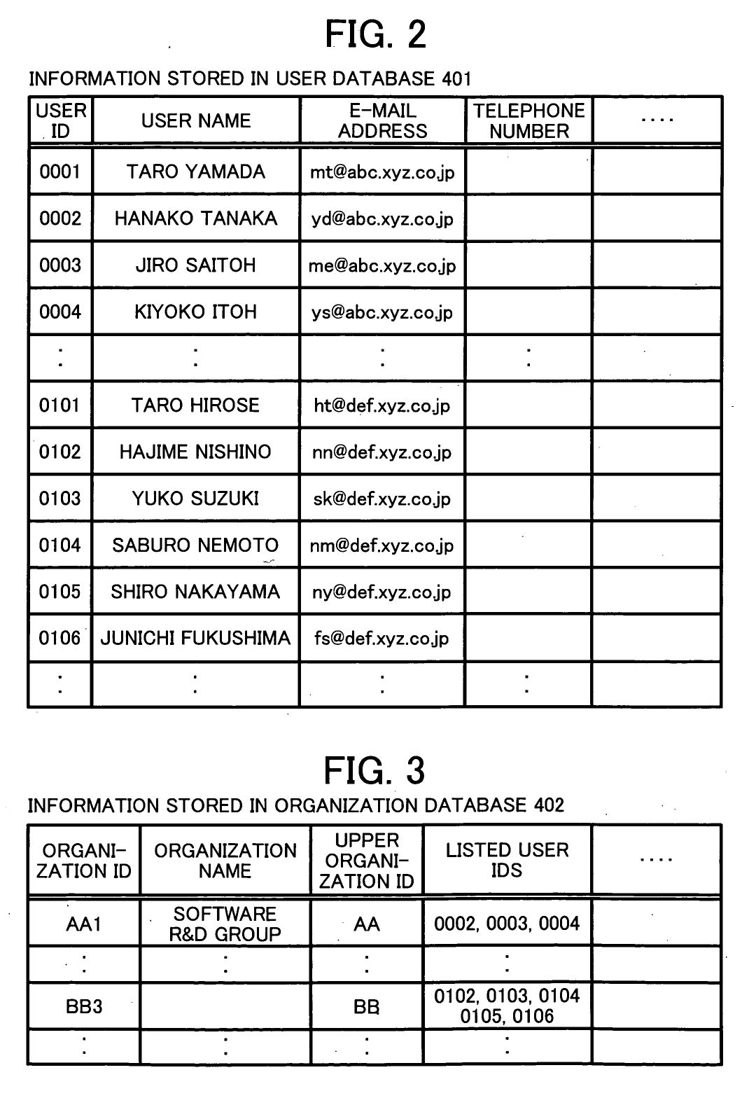

The user database 401 maintains and manages personnel data of the staff members and the like. As illustrated in FIG. 2, the user database 401 stores the personnel data. The stored personnel data includes a user ID for identifying a user, a user name, and a contact information such as an e-mail address and a telephone number, for example. The user database 401 is used to retrieve the user ID by the user name or, alternatively, to retrieve the user name and the contact information by the user ID.

The organization database 402 maintains and manages data about a hierarchical structure of an organization the staff members belong to and the staff members belonging to the organization. The data is handled as personnel data. As illustrated in FIG. 3, the organization database 402 stores the data. The stored data includes an organization ID for identifying an organization, an organization name, an upper organization ID, and listed user IDs of the staff members belonging to the organization, for example. The organization database 402 is used to retrieve the organization name of an organization a user belongs to and acquaintances of the user by the user ID (i.e., an author or a coauthor).

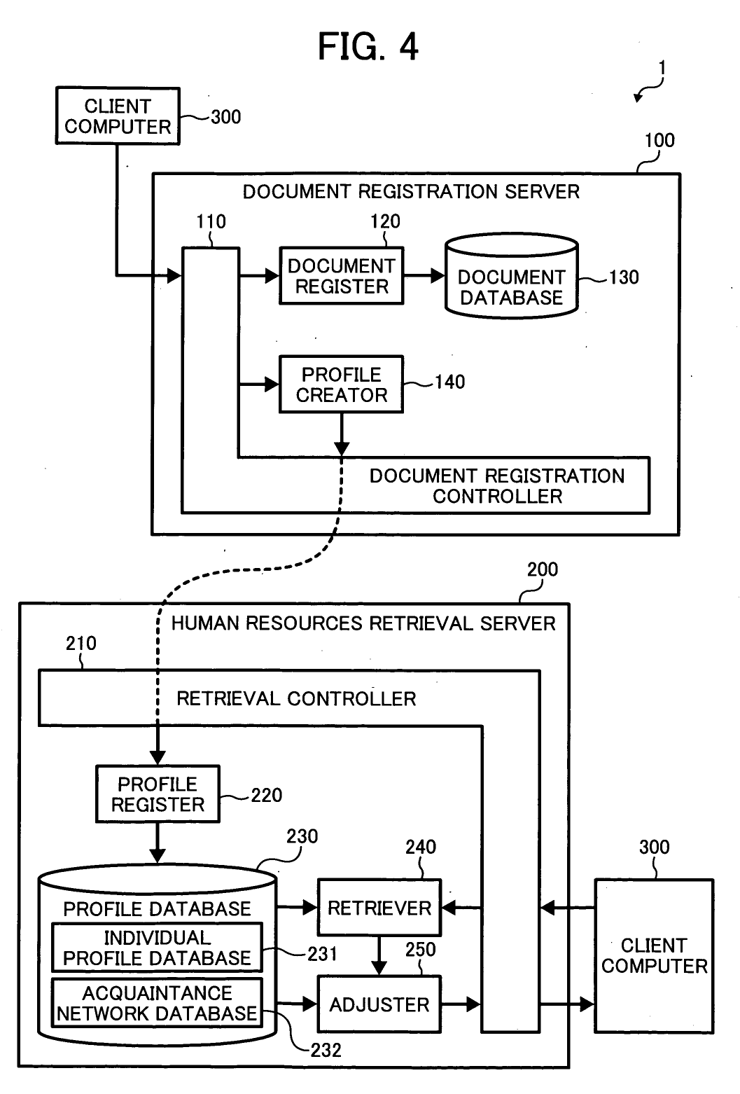

As illustrated in FIG. 4, the document registration server 100 includes a document registration controller 110, a document register 120, a document database 130, and a profile creator 140. The human resources retrieval server 200 includes a retrieval controller 210, a profile register 220, a profile database 230, a retriever 240, and an adjuster 250.

The profile database 230 includes an individual profile database 231 and an acquaintance network database 232.

The document registration controller 110 is configured to receive data for registering a document from the client computer 300 and to send the data to the document register 120 and the profile creator 140. The document register 120 is configured to add a document ID to the data and to send the data to the document database 130. The document database 130 is configured to store the data. The profile creator 140 is configured to extract keywords from the data to create a profile of the document and to send the profile to the human resources retrieval server 200. The retrieval controller 210 is configured to receive the profile and send the profile to the profile register 220. The profile register 220 is configured to create data to be registered into the profile database 230 based on the profile. The profile database 230 is configured to store the data. The retriever 240 is configured to search through the profile database 230 and retrieve human resources data. The adjuster 250 is configured to adjust the human resources data.

The individual profile database 231 is configured to store keywords and coauthor frequencies for the author ID. The acquaintance network database 232 is configured to store a network connecting an author, a coauthor, and staff members belonging to a common organization to the author.

Operations of the document database 130 for registering a document and the profile database 230 for registering a profile are explained below.

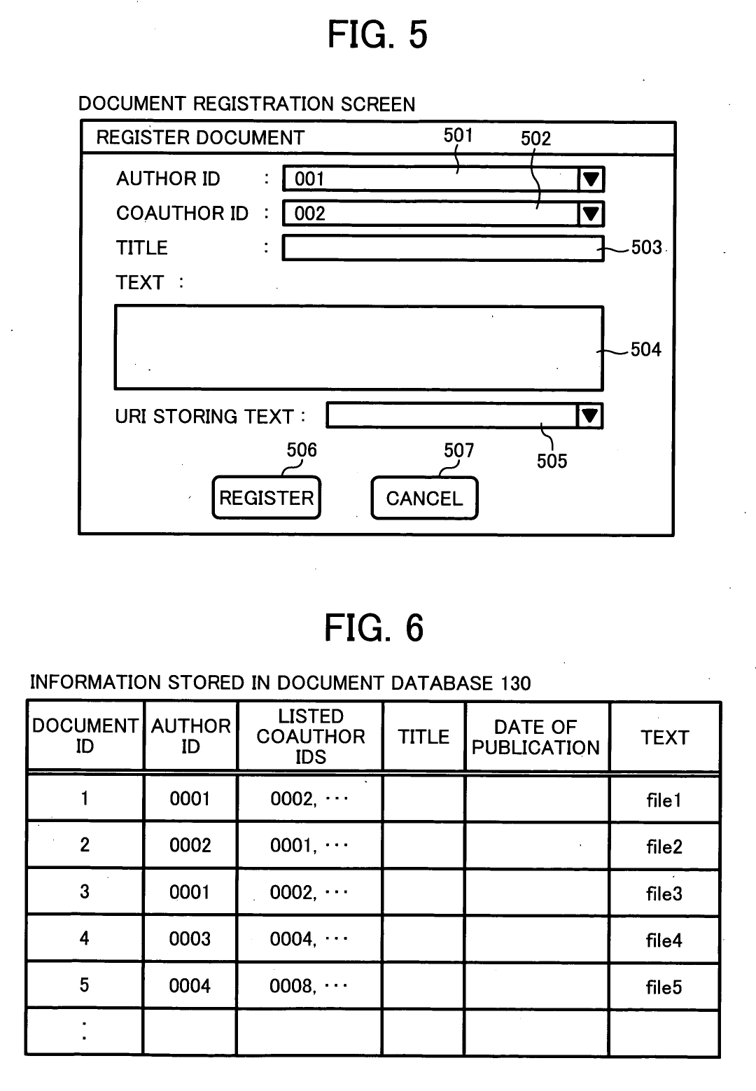

A user or an administrator who wants to register a document operates the client computer 300 to send a request to the document registration server 100 from the client computer 300. In the document registration server 100, the document registration controller 110 analyzes the request. If the request asks to register the document, the document registration controller 110 starts the document register 120 to display a document registration screen illustrated in FIG. 5. In this case, the document registration server 100 having the web server function sends a web page for registering the document to the client computer 300. Thus, a web browser installed in the client computer 300 displays the document registration screen.

As illustrated in FIG. 5, the document registration screen includes input areas 501, 502, 503, 504, and 505, and buttons 506 and 507.

The input area 501 is used to enter a user ID of an author of the document to be registered. The user database 401 is browsed to select the user ID by a user name or an affiliation of the author. The input area 502 is used to enter a user ID of a coauthor of the document to be registered. If there are a plurality of coauthors, all the coauthors are specified. If user IDs of the coauthors are unknown, the user database 401 is browsed to select the user IDs by user names or affiliations of the coauthors. The input area 503 is used to enter a title of the document to be registered. The input area 504 is used to enter text of the document to be registered. If the text is registered in any other area, a URI (Uniform Resource Identifier) in which the document is registered, for example, a path to access the registered text, may be specified in the input area 505. The button 506 is used to register data specified on the document registration screen into the document database 130. The button 507 is used to cancel registering the data.

When the user or the administrator clicks the button 506 on the client computer 300, the data specified on the document registration screen is sent to the document registration server 100. In the document registration server 100, the document registration controller 110 receives the data, and then sends the received data to the document register 120 and the profile creator 140.

The document register 120 adds a new document ID to the received data and registers the data into the document database 130. As illustrated in FIG. 6, the document database 130 stores the data. The stored data includes a document ID, an author ID, listed coauthor IDs, a title, a date of publication, and text, for example. The document ID identifies the document. The date of publication indicates a date when the document is registered. The text indicates a file name or a URI where the text is stored, for example.

The profile creator 140 extracts keywords from the title and the URI by using a known technology. For example, compound words are selected. A number of appearances in the document of a word included in each of the compound words is counted. A score is given to the word to extract candidate keywords. The candidate keywords are sorted in descending order of the scores. A predetermined number of the words top-ranked are selected and listed as the keywords. The profile creator 140 sends the author ID, the listed coauthor IDs, and the listed keywords to the human resources retrieval server 200 as a request for registering a profile.

In the human resources retrieval server 200, the retrieval controller 210 receives the request. The retrieval controller 210 starts the profile register 220 and sends the author ID, the listed coauthor IDs, and the listed keywords to the profile register 220. The profile register 220 creates data to be registered into the profile database 230 based on the author ID, the listed coauthor IDs, and the listed keywords received. The profile database 230 includes the individual profile database 231 and the acquaintance network database 232.

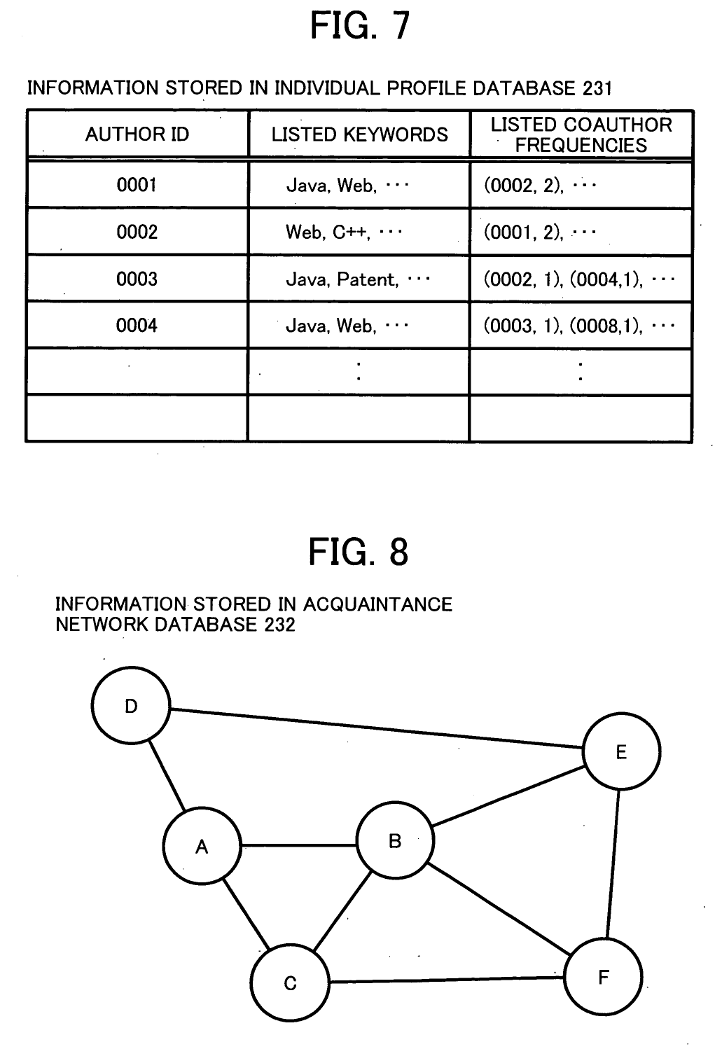

As illustrated in FIG. 7, the individual profile database 231 stores the data. The data includes an author ID, listed keywords, and listed coauthor frequencies, for example. The author ID identifies the author of the document. The listed keywords include keywords extracted from the document. The listed coauthor frequencies include combinations of the coauthor ID and a frequency. The frequency indicates how many times the coauthor has acted as a coauthor for the author.

As illustrated in FIG. 8, the acquaintance network database 232 stores a network connecting the author, the coauthor, and the staff members belonging to the common organization to the author. In the network, the author is acquainted with the coauthor. The author is acquainted with the staff members belonging to the common organization. The organization database 402 is referred to create a network (i.e., an initial state) in which the staff members belonging to the common organization (for example, a common section or a common project team) are acquainted with each other. As illustrated in FIG. 8, a staff member B is acquainted with staff members A, C, E, and F.

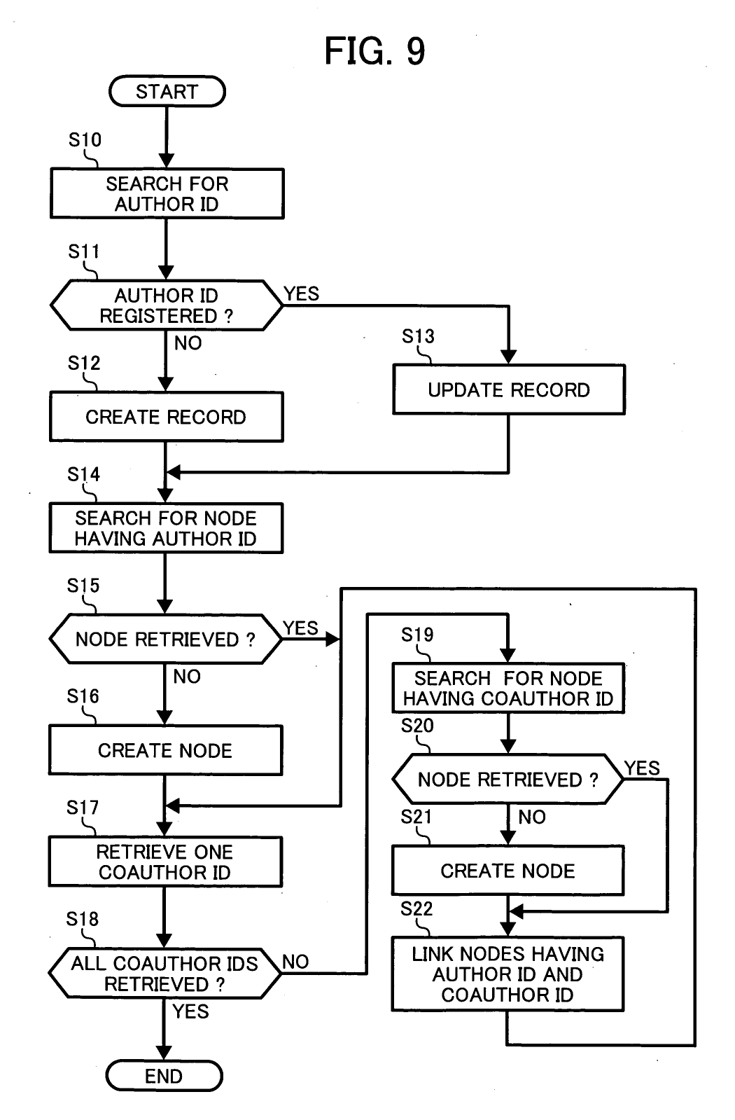

Referring to FIG. 9, operations of the profile register 220 are explained below. In a step S10, the individual profile database 231 is searched through to search for the received author ID. In a step S11, whether or not the author ID is registered in the individual profile database 231 is checked. If the author ID is not registered (i.e., if NO is selected in the step S11), a record for the author ID is newly created and stored together with the listed keywords and the listed coauthor frequencies in a step S12. The listed keywords are stored in a state that the keywords do not overlap. To register the listed coauthor frequencies, a different coauthor ID is extracted to create and store a combination of the coauthor ID and a frequency numbered with 1.

If the author ID is registered (i.e., if YES is selected in the step S11), the listed keywords are stored into a record for the retrieved author ID in a state that the keywords do not overlap. To register the listed coauthor frequencies, a frequency is counted up by 1 for a common coauthor ID. A frequency for a different coauthor ID is numbered with 1. Thus, the combination of the coauthor ID and the frequency is updated in a step S13.

In a step S14, the acquaintance network database 232 is searched through to search for a node having the author ID. If the node is not retrieved (i.e., if NO is selected in a step S15), a node having the author ID is created in a step S16. If the node is retrieved (i.e., if YES is selected in the step S15), one coauthor ID is retrieved from the listed coauthor IDs in a step S17. If all the coauthor IDs are retrieved (i.e., if YES is selected in a step S18), the operations for profile registration are completed.

If all the coauthor IDs are not retrieved (i.e., if NO is selected in the step S18), the acquaintance network database 232 is searched through to search for a node having a coauthor ID in a step S19. If the node is not retrieved (i.e., if NO is selected in a step S20), a node having the coauthor ID is created in a step S21. The node having the author ID is linked with the node having the coauthor ID in a step S22. Then, the step 17 is repeated to retrieve a node having a next coauthor ID. If the node is retrieved (i.e., if YES is selected in the step S20), the node having the author ID is linked with the node having the coauthor ID in the step S22. Then, the step 17 is repeated to retrieve a node having the next coauthor ID.

As described above, the profile of the user can be automatically extracted from the document the user created. In this case, the profile includes the listed keywords extracted from the document. Thus, the user can be free from extra workload.

Operations for searching for a person satisfying a search condition specified by a searcher are explained below.

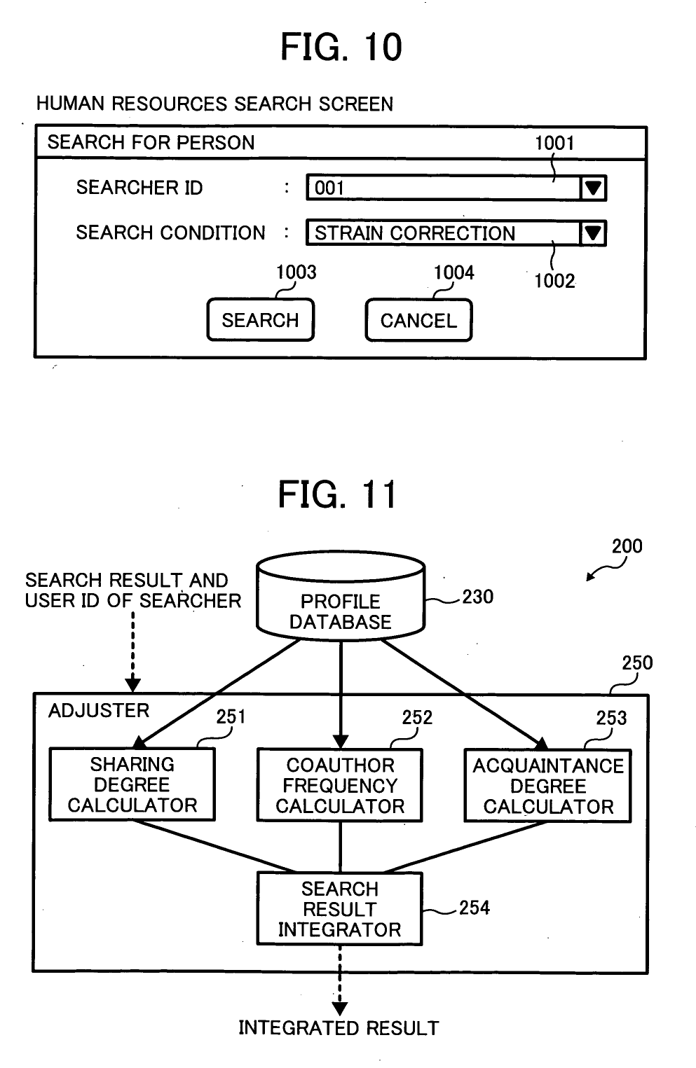

The searcher operates the client computer 300 to send a request to the human resources retrieval server 200 from the client computer 300. In the human resources retrieval server 200, the retrieval controller 210 analyzes the request. If the request asks to search for the person, the retrieval controller 210 starts the retriever 240 to display a human resources search screen illustrated in FIG. 10. In this case, the human resources retrieval server 200 including the web server function sends a web page for searching for the person to the client computer 300. Thus, a web browser installed in the client computer 300 displays the human resources search screen.

As illustrated in FIG. 10, the human resources search screen includes input areas 1001 and 1002 and buttons 1003 and 1004.

The input area 1001 is used to enter a user ID of the searcher who searches for the person. The input area 1002 is used to enter the search condition for searching for the person. The button 1003 is used to start a search by using data specified on the human resources search screen. The button 1004 is used to cancel the search.

When the searcher clicks the button 1003 on the client computer 300, the data specified on the human resources search screen is sent to the human resources retrieval server 200. In the human resources retrieval server 200, the retrieval controller 210 receives the data, and then sends the received data to the retriever 240.

The retriever 240 refers to the listed keywords stored in the individual profile database 231 to search for author IDs satisfying the received search condition. The retriever 240 outputs listed author IDs as a search result. The search is performed by using a known technology.

An association degree with each author ID is calculated based on the search result so as to create a combination of the author ID and the association degree. The combinations are listed and temporarily stored.

Listed keywords for the authors included in the search result are extracted from documents created by the authors and coauthors. Therefore, the listed keywords include properties of the coauthors. The properties of the coauthors are excluded to calculate an association degree between the author and the search condition in accordance with an equation (1) below. K_{id} represents the association degree between the author and the search condition.
K_{id}=mA+Σⱼ{nⱼ} (1)

In the equation (1), K_{id} represents the association degree when the author ID is id. m represents a number of the author whose author ID is id in the search result. m is either 0 or 1. A is a constant ranging from 0 to 1. Σⱼ represents a total number of frequencies of the coauthor IDs for the author whose author ID is id in listed coauthor frequencies of the authors included in the search result.

The retriever 240 starts the adjuster 250, and then sends the search result and the user ID of the searcher to the adjuster 250.

As illustrated in FIG. 11, the adjuster 250 includes a sharing degree calculator 251, a coauthor frequency calculator 252, an acquaintance degree calculator 253, and a search result integrator 254.

The sharing degree calculator 251 is configured to calculate a knowledge sharing degree between the searcher and the author to create a combination of the author ID and the knowledge sharing degree. The coauthor frequency calculator 252 is configured to calculate a coauthor frequency between the searcher and the coauthor to create a combination of the author ID and the coauthor frequency. The acquaintance degree calculator 253 is configured to calculate an acquaintance degree between the searcher and the author to create a combination of the author ID and the acquaintance degree. The search result integrator 254 is configured to integrate the association degree, the knowledge sharing degree, the coauthor frequency, and the acquaintance degree to create an integrated result.

According to the present embodiment, the knowledge sharing degree, the coauthor frequency, and the acquaintance degree are used as indexes for adjustment. However, the other indexes may be added or replaced with the above indexes if the other indexes are useful for searching for the person.

The sharing degree calculator 251 compares a profile of the searcher with a profile retrieved per author ID in the search result. Thus, the sharing degree calculator 251 calculates the knowledge sharing degree, and temporarily stores the calculated knowledge sharing degree as the combination of the author ID and the knowledge sharing degree.

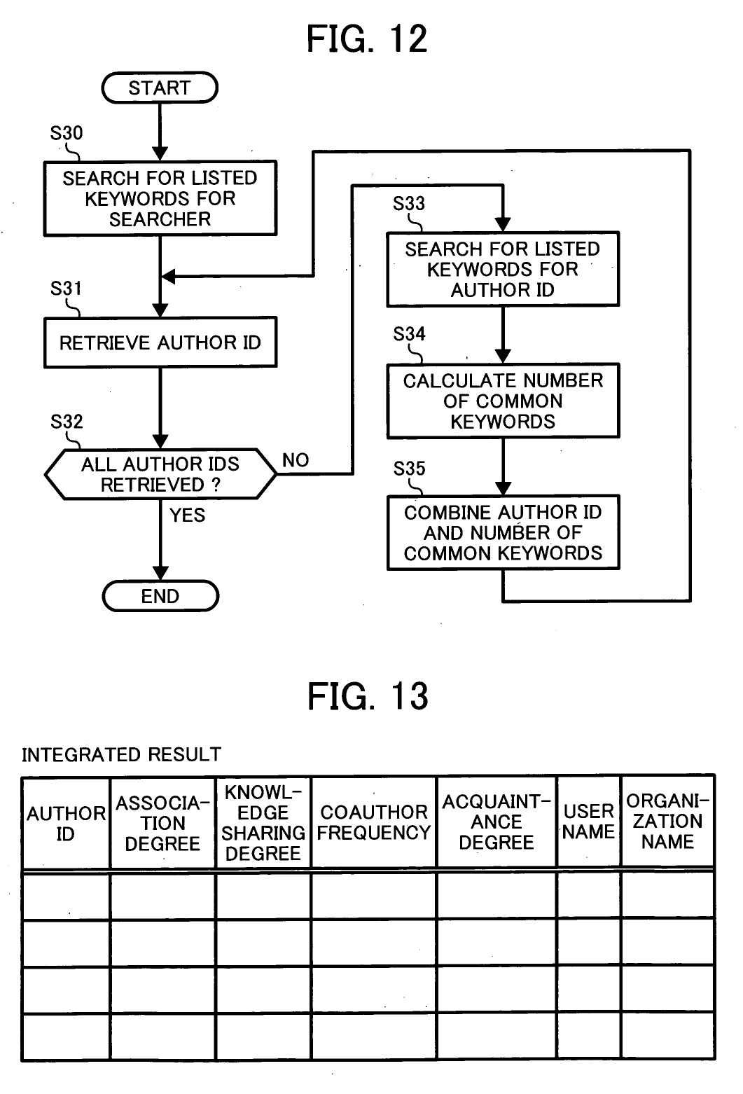

Referring to FIG. 12, processes for calculating the knowledge sharing degree are explained. According to the present embodiment, the listed keywords indicate the profile.

In a step S30, the individual profile database 231 is searched through to retrieve listed keywords corresponding to the user ID of the searcher. In a step S31, author IDs for which the combination of the author ID and the knowledge sharing degree is not created are retrieved from the search result output by the retriever 240. If the combination of the author ID and the knowledge sharing degree is created for all the author IDs retrieved in the step S31 (i.e., if YES is selected in a step S32), the sharing degree calculator 251 outputs listed combinations of the author ID and the knowledge sharing degree as a calculation result.

If there is an author ID for which the combination of the author ID and the knowledge sharing degree is not created (i.e., if NO is selected in the step S32), the individual profile database 231 is searched through to retrieve listed keywords corresponding to the author ID in a step S33. In a step S34, the listed keywords corresponding to the author ID are compared with the listed keywords corresponding to the user ID of the searcher to calculate a number of common keywords as the knowledge sharing degree. In a step S35, the combination of the author ID and the knowledge sharing degree is created and temporarily stored. The processes are repeated from the step S31.

The coauthor frequency calculator 252 refers to the individual profile database 231 to retrieve listed coauthor frequencies corresponding to the user ID of the searcher, and then stores the listed coauthor frequencies retrieved. Thus, the coauthor frequency calculator 252 calculates how many times the searcher has created documents together with each of the retrieved coauthors.

The acquaintance degree calculator 253 refers to the acquaintance network database 232 to find a route from a node having the user ID of the searcher to a node having the author ID retrieved by the retriever 240. The acquaintance degree calculator 253 calculates a number of nodes on the route (i.e., a number of hops) as the acquaintance degree. If there are a plurality of routes, a route having a fewest number of hops is selected. The fewest number of hops is defined as the acquaintance degree. The acquaintance degree calculator 253 calculates the acquaintance degree for each of the author IDs retrieved by the retriever 240 so as to create and temporarily store listed combinations of the author ID and the acquaintance degree.

The search result integrator 254 associates each of the author IDs with the association degree, the knowledge sharing degree, the coauthor frequency, and the acquaintance degree respectively output by the retriever 240, the sharing degree calculator 251, the coauthor frequency calculator 252, and the acquaintance degree calculator 253 so as to create an integrated result as illustrated in FIG. 13. The search result integrator 254 refers to the user database 401 to retrieve a user name corresponding to the author ID and adds the retrieved user name to the integrated result. The search result integrator 254 further refers to the organization database 402 to retrieve an organization name corresponding to the author ID and adds the retrieved organization name to the integrated result.

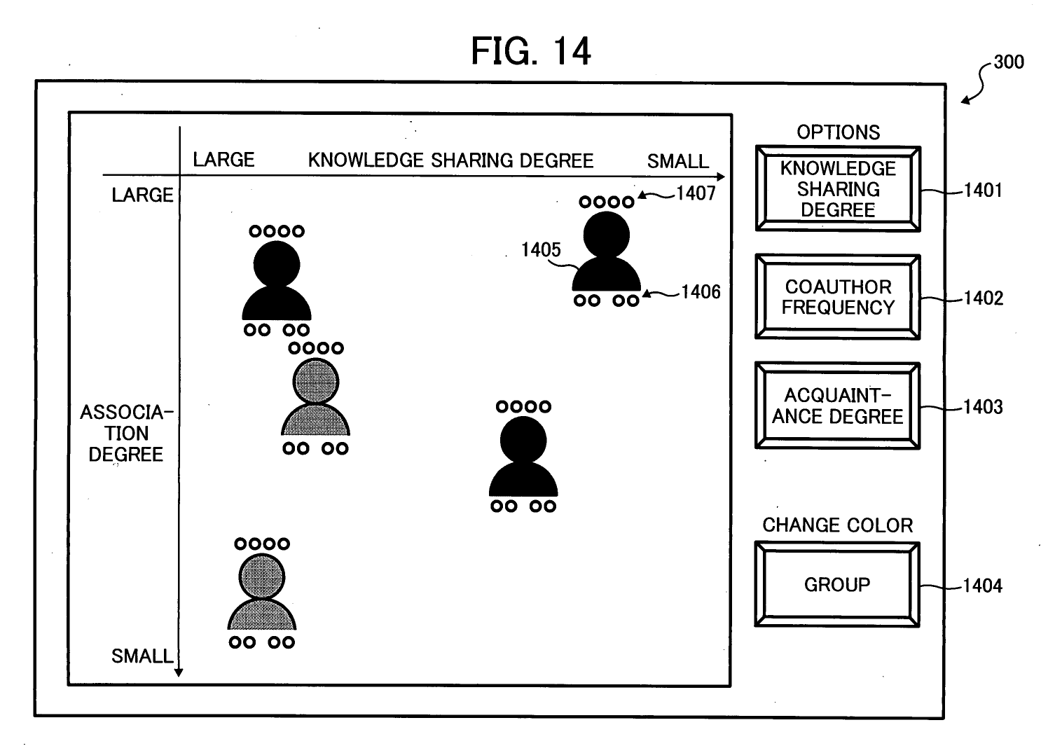

The integrated result is sent to the client computer 300 of the searcher so that the web browser displays the integrated result as illustrated in FIGS. 14 to 16.

As described above, it is possible to provide the indexes for adjusting the search result retrieved based on the search condition by using the profile of the searcher. Thus, optimum persons for the searcher can be retrieved from a plurality of points of view.

As illustrated in FIG. 14, the client computer 300 includes buttons 1401, 1402, 1403, and 1404, an icon 1405, and character strings 1406 and 1407.

The icon 1405 is configured to represent a person retrieved (e.g., an author). The character string 1406 is configured to represent an author name. The character sting 1407 is configured to represent an organization name the author belongs to. The button 1404 is used to change a color of the icon 1405 per organization the author belongs to. The button 1401 is used to map the icon 1405 based on the knowledge sharing degree. The button 1402 is used to map the icon 1405 based on the coauthor frequency. The button 1403 is used to map the icon 1405 based on the acquaintance degree.

The client computer 300 of the searcher displays the search result sent from the human resources retrieval server 200. Human resources data of the search result is mapped on a coordinate plate as illustrated in FIG. 14. A vertical axis represents the association degree. A horizontal axis represents a selected index (e.g., the knowledge sharing degree, the coauthor frequency, or the acquaintance degree). On the horizontal axis, the degree is larger on the left and smaller on the right. On the vertical axis, the degree is larger on the top and smaller on the bottom.

When any one of the buttons 1401, 1402, and 1403 is clicked, the horizontal axis represents the index corresponding to the clicked button. The icon 1405 and the character strings 1406 and 1407 represent the human resources data. The color of the icon 1405 is graded in accordance with a value of the index other than the index represented by the horizontal axis.

For example, when the horizontal axis represents the knowledge sharing degree as illustrated in FIG. 14, the icon 1405 is painted in light blue if the acquaintance degree is small and the icon 1405 is painted in deep blue if the acquaintance degree is large. The color of the icon 1405 may also be graded in accordance with the coauthor frequency instead of the acquaintance degree.

When the button 1404 is clicked, authors in a same organization (i.e., group) are painted in a same color. Thus, the color of the icon 1405 differs depending on the organization and is graded in accordance with a value of the selected index.

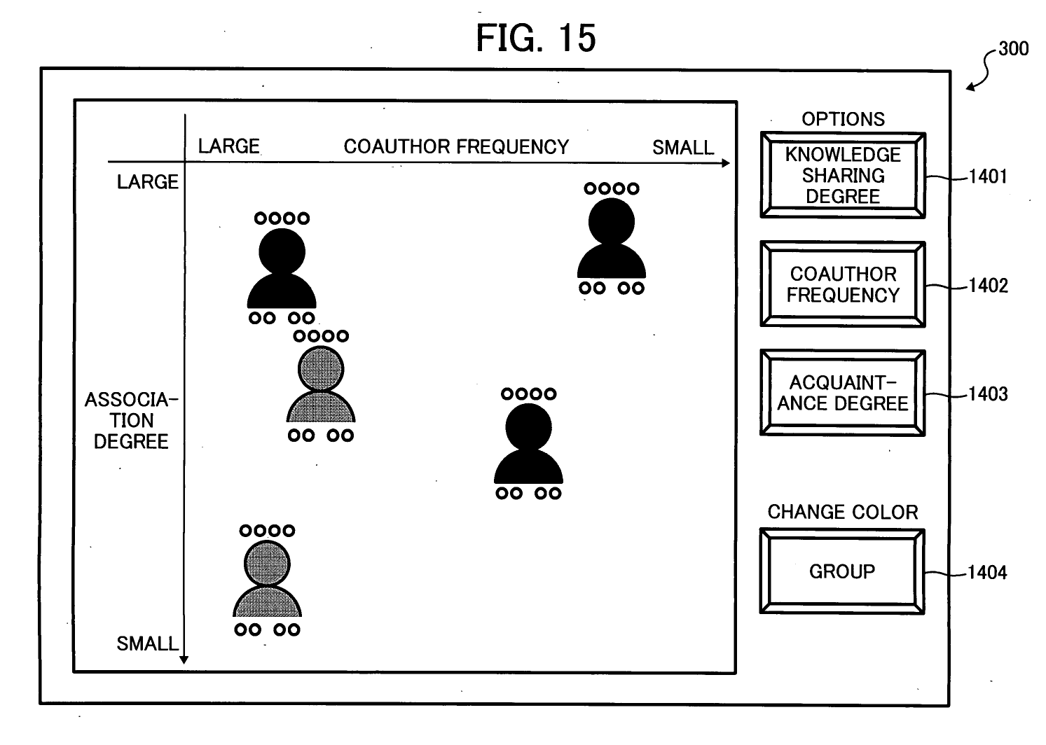

When the button 1402 is clicked, the knowledge sharing degree represented by the horizontal axis is cleared. Instead of the cleared knowledge sharing degree, the coauthor frequency is represented by the horizontal axis. Simultaneously, mapping of the human resources data changes as illustrated in FIG. 15. The color of the icon 1405 is cleared. The gradation of the color of the icon 1405 is changed in accordance with a value of the knowledge sharing degree.

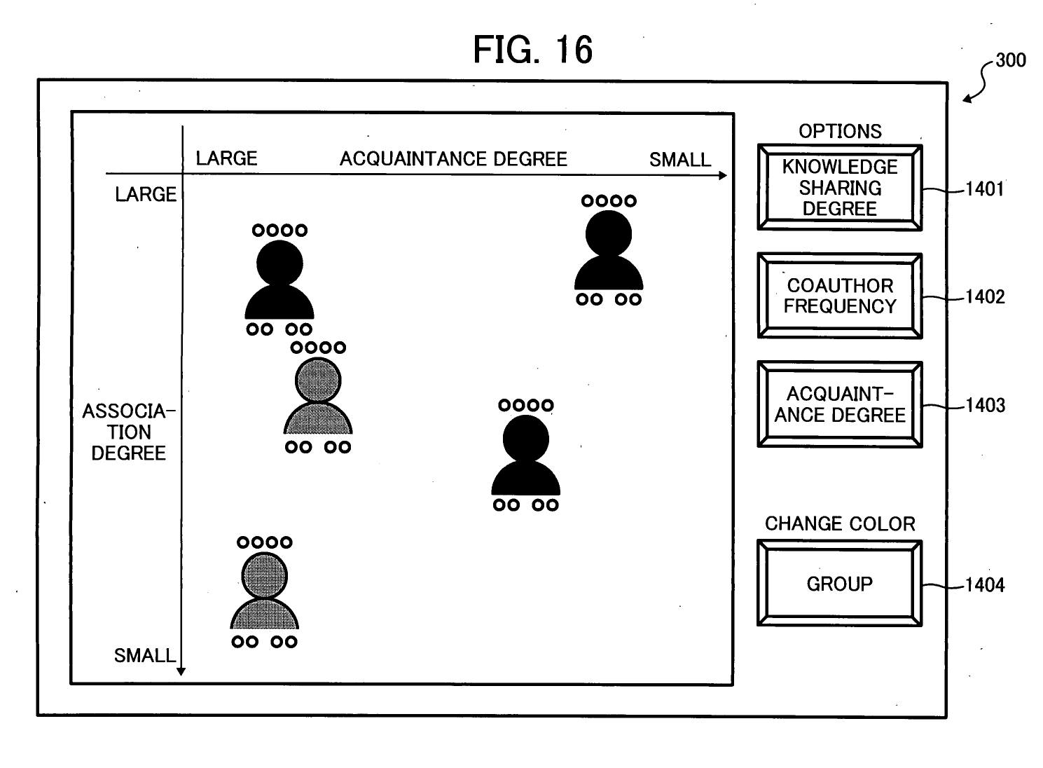

When the button 1403 is clicked, the coauthor frequency represented by the horizontal axis is cleared. Instead of the cleared coauthor frequency, the acquaintance degree is represented by the horizontal axis. Simultaneously, mapping of the human resources data changes as illustrated in FIG. 16. The color of the icon 1405 is cleared. The gradation of the color of the icon 1405 is changed in accordance with the value of the knowledge sharing degree.

When the icon 1405 is clicked, a user ID of a person represented by the icon 1405 may be sent to the document registration server 100. Thus, detailed data about the person, for example, an organization name, a user name, contact information, a title of a document stored in the document database 130, and a URI of the document may be retrieved and displayed. When the title of the document is clicked, text of the document may be retrieved from the URI of the document and displayed. The above operations can be carried out when programmed in advance in plug-in software of the web browser installed in the client computer 300.

As described above, the icon 1405 representing the retrieved person is plotted based on a plurality of indexes. The color of the plotted icon 1405 is changed and graded. Thus, optimum persons for the searcher can be easily found.

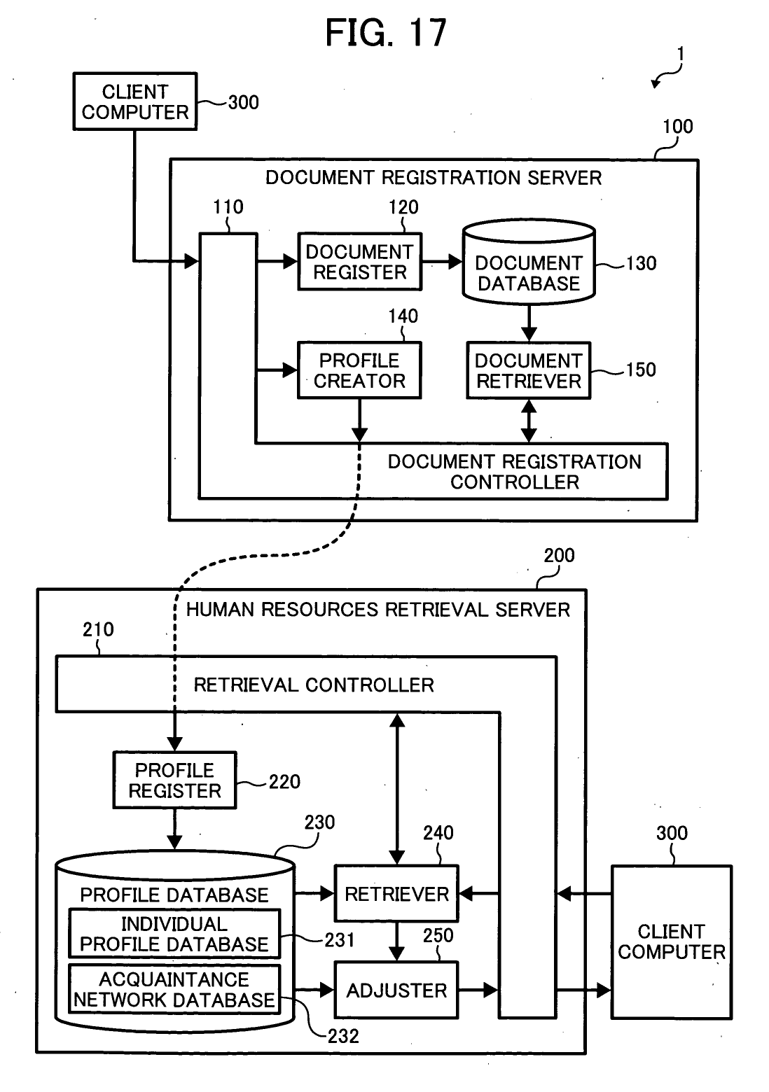

Referring to FIGS. 17 to 19, another exemplary embodiment of the present invention is explained. According to the previous embodiment, the profile database 230 is searched through to search for the person satisfying the search condition. The profile of the searcher is considered to adjust the search result. According to the present embodiment, however, the document database 130 is searched through to search for the person. The profile of the searcher is added to the search result.

As illustrated in FIG. 17, the human resources retrieval system 1 further includes a document retriever 150.

The document retriever 150 is configured to search through the document database 130 to retrieve documents satisfying a search condition.

Operations of the document database 130 for registering a document and the profile database 230 for registering a profile according to the present embodiment are similar to those according to the previous embodiment.

Operations of the document database 130 and the profile database 230 for searching for an optimum person for a searcher are explained below.

The searcher operates the client computer 300 to send a request to the human resources retrieval server 200 from the client computer 300. In the human resources retrieval server 200, the retrieval controller 210 analyzes the request. If the request asks to search for a person, the retrieval controller 210 starts the retriever 240 to display the human resources search screen illustrated in FIG. 10. In this case, the human resources retrieval server 200 including the web server function sends a web page for searching for the person to the client computer 300. Thus, a web browser installed in the client computer 300 displays the human resources search screen.

The searcher specifies a user ID of the searcher and a search condition on the human resources search screen. When the searcher clicks the button 1003, data specified on the human resources search screen is sent to the human resources retrieval server 200. In the human resources retrieval server 200, the retrieval controller 210 sends the received data to the retriever 240. The retriever 240 sends the request for searching for the person with the search condition to all the document registration servers 100 connected to the human resources retrieval server 200 via the retrieval controller 210, and monitors replies.

In each of the document registration servers 100, the document registration controller 110 receives the request and the search condition, and starts the document retriever 150. The document retriever 150 searches through the document database 130 to search for documents satisfying the search condition by using a known technology, for example, ranking search. A score is calculated for each of the documents by using a following equation (2). The searched documents are ranked based on their scores. A predetermined number of top-ranked documents are retrieved. A combination of the document ID, the author ID, the listed coauthor IDs, and the score is created for each of the retrieved documents. The combinations are listed and sent to the human resources retrieval server 200.
s=Σ_{w} s(w) (2)

In the equation (2), s represents the score. w represents a search word specified as the search condition. s(w) represents the score of the search word. Σw represents adding all the scores of the search words.
S(w)=tf(w)*(1+log₂ (N/df(w))) (3)

In an equation (3), tf(w) represents a number of the search words appearing in the document. N represents a number of documents registered in the document database 130. df(w) represents a number of documents containing the search words which are stored in the document database 130.

When the retriever 240 receives search results from all the document registration servers 100, the retriever 240 combines the search results and calculates the number of documents and the association degree between the searcher and the author per author ID based on the combined search results to create combinations of the author ID, the number of documents, and the association degree. Then, the retriever 240 temporarily stores the combinations.

The combined search results are sorted by the author ID to calculate the number of documents per author ID. The documents retrieved in the search results are created by authors and coauthors. The scores of the documents include properties of the coauthors. The properties of the coauthors are excluded to calculate the association degree between the author and the search condition.

Documents corresponding to the author ID or the coauthor ID that appears in the listed coauthor IDs for the author ID are retrieved from the search results. A total value is calculated based on the score of each of the documents. Different values are assigned to the author and coauthor. The association degree between the author and the search condition is calculated in accordance with an equation (4) below.
K_{ID}=Sⱼ{Wⱼ*Sⱼ/Sₘₐₓ} (4)

In the equation (4), K_{ID} represents the association degree between the author and the search condition. Sj represents adding values of documents having the user ID that appears as the author ID or in the listed coauthor IDs for the retrieved documents. Sⱼ represents the score of a document Dⱼ. Sₘₐₓ represents a maximum score among the scores of the retrieved documents. Wⱼ represents a value which differs depending on whether the user ID represents the author or the coauthor.

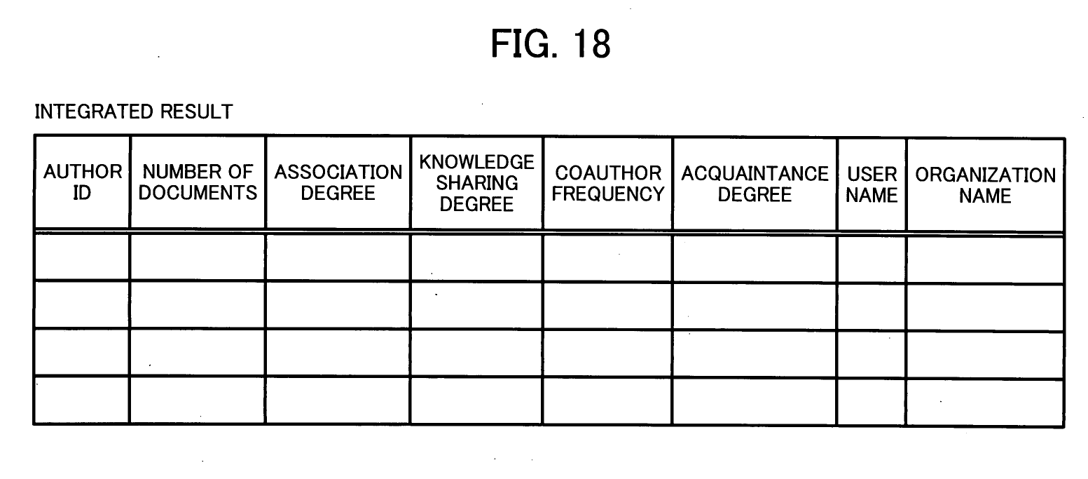

As illustrated in FIG. 18, the search result integrator 254 adds the number of documents to the integrated result according to the previous embodiment. The integrated result is sent to the client computer 300 so that the web browser displays the integrated result as illustrated in FIGS. 14 to 16.

The search result is displayed in a manner similar to that according to the previous embodiment. The number of documents may be added as another index. The color of the icon 1405 may be graded based on the number of documents.

As described above, effects similar to the effects according to the previous embodiment can be obtained according to the present embodiment.

According to the previous embodiment, whenever a document is to be registered, the document registration server 100 extracts a profile of an author corresponding to the document. The profile is registered into the profile database 230 of the human resources retrieval server 200. However, the client computer 300 may include a local profile creator and register the profile into a local profile database in the client computer 300. In this case, the local profile creator may send data stored in the local profile database to the human resources retrieval server 200. In the human resources retrieval server 200, the profile register 220 may receive and register the data into the profile database 230.

The human resources retrieval server 200 may be connected with the client computers 300. The human resources retrieval server 200 may periodically access the local profile databases of the client computers 300 to combine data in the local profile databases and to create a profile database for the human resources retrieval server 200.

When a searcher searches for a person, the searcher may specify the local profile database as well as a user ID of the searcher and a search condition. Thus, the data stored in the local profile database may be sent to the human resources retrieval server 200 and used by the retriever 240 and the adjuster 250 as a profile of the searcher.

The profile may be created based on a predetermined format so that the profile may be extracted by the format as well as by the document. Thus, a user who does not create the document but has knowledge can use the human resources retrieval system 1 to search for a person.

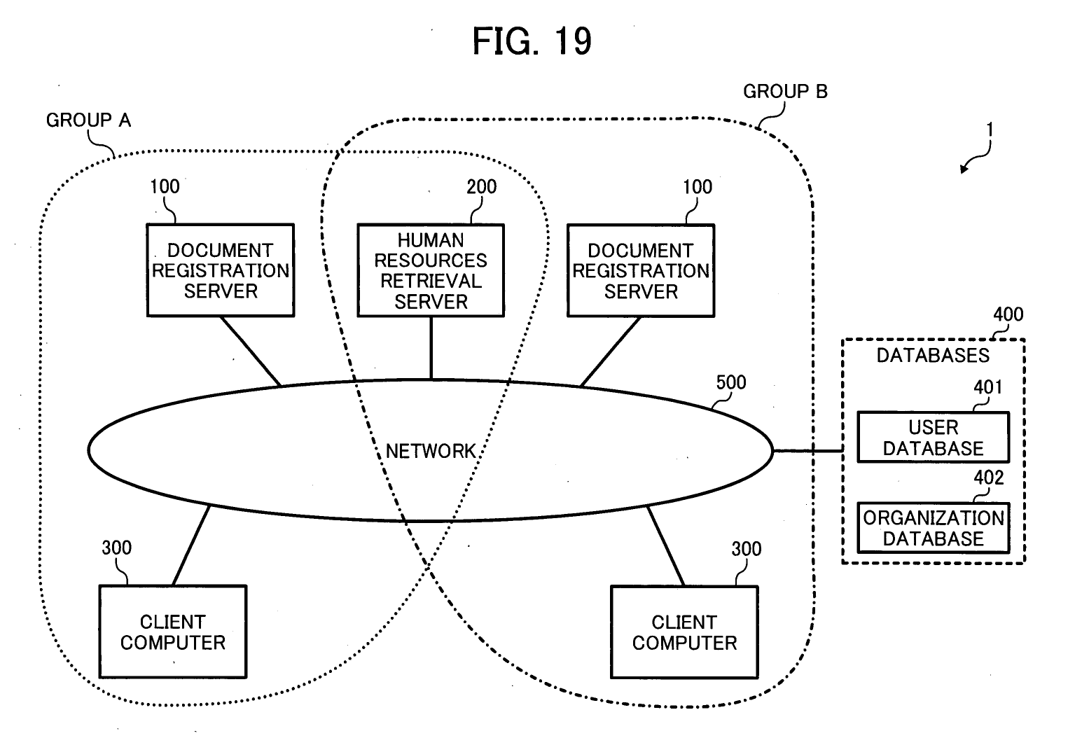

As illustrated in FIG. 19, a document created by a user belonging to a plurality of groups (i.e., groups A and B) may be stored into the document registration servers 100 of the groups A and B. Profiles corresponding to the document may be created in the document registration servers 100 of the groups A and B. The profiles may be stored into the profile database 230 of the human resources retrieval server 200 which is shared by the groups A and B.

The groups A and B may respectively have the document registration servers 100 or share the document registration server 100.

When the groups A and B share the profile database 230 of the human resources retrieval server 200, searchers in the groups A and B can search for a person in a manner similar to that according to the previous embodiment.

When the profile database 230 of the human resources retrieval server 200 is managed per group, for example, a searcher in the group A may search through the profile database 230 of the group B to search for a person in the group B. The searcher may specify a profile of the searcher in the profile database 230 of the group A. Thus, the search can be performed in a manner similar to that according to the previous embodiment.

In an electronic bulletin board system, a response message is submitted to a message posted on an electronic bulletin board. When the previous embodiment is applied to the electronic bulletin board system, data about a user (e.g., an author) who writes the response message obtained from the response message (for example, a response speed and a response frequency) can be added to a profile of the user. If the data is provided to a searcher, the searcher can judge whether the searcher can easily contact or communicate with the user.

If the authors of the message and the response message who belong to a certain thread know each other, data stored in the acquaintance network database 232 can be updated to add data obtained from the message and the response message. Thus, reliability in the acquaintance degree between the authors may improve.

The present invention is not limited to the details of the above embodiments. Functions of the devices used in the above embodiments are programmed and written onto a recording medium such as a CD-ROM (Compact Disc Read Only Memory). The CD-ROM is inserted into a medium driving device such as a CD-ROM drive provided in a computer, so that a program is installed and executed. Thus, the present invention may be practiced. In this case, the program read from the recording medium practices the above embodiments. Therefore, the program and the recording medium storing the program may practice the present invention.

The recording medium may include a semiconductor medium such as a ROM (Read Only Memory) and a nonvolatile memory card, an optical medium such as a DVD (Digital Versatile Disc), an MO (Magnet-Optical) disc, an MD (Mini Disc), and a CD-R (Compact Disc Recordable), and a magnetic medium such as a magnetic tape and a flexible disc. The program stored in a recording device of a server may be supplied via a communication network such as the Internet. In this case, the recording device of the server may be included in the recording medium of the present invention.

The functions described in the above embodiments may be practiced by executing the loaded program. The functions may also be practiced in accordance with instructions of the program by using an operating system or other applications.

The program may be stored in the recording device such as a magnetic disc of the server. The program may be executed in accordance with instructions of a client computer connected via the communication network such as the Internet. A result obtained by executing the program may be sent to the client computer through a service provided by an application service provider. In this case, the recording device of the server and the program may practice the present invention.

The program providing the functions described in the above embodiments and the recording medium storing the program are distributed so that the program is installed into an inner or an outer recording device of the client computer. The installed program is executed to practice the functions described in the above embodiments, resulting in improvement in cost reduction, portability, and versatility.

The present invention has been described above with reference to specific embodiments. Note that the present invention is not limited to the details of the embodiments described above, but various modifications and improvements are possible without departing from the spirit and scope of the invention. It is therefore to be understood that within the scope of the appended claims, the present invention may be practiced otherwise than as specifically described herein. For example, elements and features of different illustrative embodiments may be combined with each other, substituted for each other, or both, within the scope of the present invention and appended claims.

What is claimed is:

1. A human resources retrieval system, comprising:
a client computer connected to a network and configured to specify a search condition; and
a human resources retrieval device connected to the network, and configured to perform a personnel search responsive to said search condition and to send a search result to the client computer, the human resources retrieval device comprising:
a profile database configured to store personnel profiles, said personnel profiles containing human resources data;
a retriever configured to search the profile database for said human resources data in accordance with the search condition specified by the client computer; and
an adjuster configured to adjust the human resources data by referring to a profile of a searcher and profiles corresponding to the human resources data stored in the profile database.

2. The human resources retrieval system according to claim 1,
wherein the search result sent to the client computer includes the human resources data adjusted by the adjuster.

3. The human resources retrieval system according to claim 1,
wherein the profile of the searcher is stored in the profile database.

4. The human resources retrieval system according to claim 1,
wherein the profile of the searcher is externally entered.

5. The human resources retrieval system according to claim 1, further comprising:
a document registration device connected to the network and comprising:
a document database configured to store documents and human resources data of respective authors of said documents,
wherein the retriever is configured to search the profile database and the document database for human resources data in accordance with the search condition specified by the client computer, the human resources data including data of authors corresponding to documents satisfying the search condition.

6. The human resources retrieval system according to claim 5, wherein the document registration device further comprises a profile creator configured to create a profile containing human resources data of an author from a document to be registered, and
wherein the human resources retrieval device further comprises a profile register configured to associate the profile created by the profile creator with the author and to register the associated profile into the profile database.

7. The human resources retrieval system according to claim 1, wherein the client computer comprises a profile creator configured to create a profile containing human resources data of an author from a document created by the client computer and to send the created profile to the human resources retrieval device, and
wherein the human resources retrieval device further comprises a profile register configured to associate the profile sent from the client computer with the author and to register the associated profile into the profile database.

8. The human resources retrieval system according to claim 6,
wherein the profile creator creates the profile of the author by extracting a keyword from the document to be registered.

9. The human resources retrieval system according to claim 1,
wherein the adjuster outputs the data adjusted by a plurality of adjustment methods.

10. The human resources retrieval system according to claim 1,
wherein the profile database stores data about acquaintance degrees among personnel, and the adjuster outputs an acquaintance degree among personnel corresponding to the human resources data and the searcher.

11. The human resources retrieval system according to claim 1,
wherein the adjuster refers to the profile of the searcher and the profile of personnel corresponding to the human resources data to calculate and output a knowledge sharing degree between the personnel and the searcher.

12. The human resources retrieval system according to claim 1,
wherein the client computer comprises a display configured to display an element plotted by using a plurality of axes to show the human resources data output by the adjuster.

13. The human resources retrieval system according to claim 12,
wherein the display shows the human resources data by changing at least one of a color and a gradation of the element.

14. A human resources registration device, comprising:
a profile database configured to store human resources data used for performing a personnel search in accordance with a search condition;
a profile creator configured to create a profile of an author from a document created by the author; and
a profile register configured to associate the profile created by the profile creator with the author and to register the profile into the profile database.

15. The human resources registration device according to claim 14,
wherein the profile creator creates the profile of the author by extracting a keyword from the document.

16. A human resources retrieval device for performing a personnel search in accordance with a search condition, comprising:
a profile database configured to store personnel profiles containing human resources data;
a retriever configured to search the profile database for human resources data in accordance with the search condition; and
an adjuster configured to adjust the human resources data by referring to a profile of a searcher and profiles corresponding to the human resources data stored in the profile database.

17. The human resources retrieval device according to claim 16, wherein a search result retrieved by the retriever includes the human resources data adjusted by the adjuster.

18. The human resources retrieval device according to claim 16, wherein the profile of the searcher is stored in the profile database.

19. The human resources retrieval device according to claim 16, wherein the profile of the searcher may be entered externally from said human resources retrieval device.

20. The human resources retrieval device according to claim 16, further comprising:
a document database configured to store documents accompanied by data of respective authors,
wherein the retriever is configured to search the profile database and the document database for human resources data in accordance with the search condition, the human resources data including data of authors corresponding to documents satisfying the search condition.

21. A human resources retrieval system, comprising:
means for specifying a search condition and being connected to a network; and
means for performing a personnel search, sending a search result to the means for specifying, and being connected to the network, the means for performing comprising:
means for storing personnel profiles containing human resources data;
means for searching the means for storing for human resources data in accordance with the search condition specified by the means for specifying; and
means for adjusting the human resources data by referring to a profile of a searcher and profiles corresponding to the human resources data stored in the means for storing.

22. A human resources registration device, comprising:
means for storing human resources data used for performing a personnel search in accordance with a search condition;
means for creating a profile containing human resources data of an author from a document created by the author; and
means for associating the profile with the author and registering the associated profile into the means for storing.

23. A human resources retrieval device for performing a personnel search in accordance with a search condition, comprising:
means for storing personnel profiles containing human resources data;
means for searching the means for storing for human resources data in accordance with the search condition; and
means for adjusting the human resources data by referring to a profile of a searcher and profiles corresponding to the human resources data stored in the means for storing.

24. A human resources registration method for registering human resources data used for performing a personnel search in accordance with a search condition into a profile database, the human resources registration method comprising the steps of:
creating a profile containing human resources data of an author by using a keyword extracted from a document created by the author;
associating the profile with the author; and
registering the associated profile into the profile database.

25. A human resources retrieval method for performing a personnel search in accordance with a search condition, comprising the steps of:
storing personnel profiles containing human resources data into a profile database;
searching the profile database for human resources data in accordance with the search condition; and
adjusting the human resources data by referring to a profile of a searcher and profiles corresponding to the human resources data stored in the profile database.

26. A human resources retrieval method for performing a personnel search in accordance with a search condition, comprising the steps of:
storing personnel profiles into a profile database;
storing documents accompanied by data of respective authors into a document database;
searching the document database for author data of a document satisfying the search condition as human resources data; and
adjusting the human resources data by referring to a profile of a searcher and profiles corresponding to the human resources data stored in the profile database.

27. A computer program product having computer readable program code means for, when executed on a computer system, carrying out a human resources registration method comprising the steps of:
creating a profile containing human resources data of an author by using a keyword extracted from a document created by the author;
associating the profile with the author; and
registering the associated profile into the profile database.

28. A computer program product having computer readable program code means for, when executed on a computer system, carrying out a human resources retrieval method comprising the steps of:
storing personnel profiles containing human resources data into a profile database;
searching the profile database for human resources data in accordance with the search condition; and
adjusting the human resources data by referring to a profile of a searcher and profiles corresponding to the human resources data stored in the profile database.

29. A computer program product having computer readable program code means for, when executed on a computer system, carrying out a human resources retrieval method comprising the steps of:
storing personnel profiles containing human resources data into a profile database;
storing documents accompanied by data of respective authors into a document database;
searching the document database for author data of a document satisfying the search condition as human resources data; and
adjusting the human resources data by referring to a profile of a searcher and profiles corresponding to the human resources data stored in the profile database.

30. A computer readable storage medium having recorded thereon computer readable program code means for, when executed on a computer system, carrying out a human resources registration method comprising the steps of:
creating a profile containing human resources data of an author by using a keyword extracted from a document created by the author;
associating the profile with the author; and
registering the associated profile into the profile database.

31. A computer readable storage medium having recorded thereon computer readable program code means for, when executed on a computer system, carrying out a human resources retrieval method comprising the steps of:
storing personnel profiles containing human resources data into a profile database;
searching the profile database for human resources data in accordance with the search condition; and
adjusting the human resources data by referring to a profile of a searcher and profiles corresponding to the human resources data stored in the profile database.

32. A computer readable storage medium having recorded thereon computer readable program code means for, when executed on a computer system, carrying out a human resources retrieval method comprising the steps of:
storing personnel profiles containing human resources data into a profile database;
storing documents accompanied by data of respective authors into a document database;
searching the document database for author data of a document satisfying the search condition as human resources data; and
adjusting the human resources data by referring to a profile of a searcher and profiles corresponding to the human resources data stored in the profile database.
